(19) United States
(12) Patent Application Publication
(10) Pub. No.: US 2013/0215118 A1
(43) Pub. Date: Aug. 22, 2013

(54) OPERATION STATUS VISUALIZATION SYSTEM, OPERATION STATUS VISUALIZATION METHOD, AND INFORMATION STORAGE MEDIUM STORING PROGRAM

(71) Applicant: Teruya Ikegami, Tokyo (JP)

(72) Inventor: Teruya Ikegami, Tokyo (JP)

(73) Assignee: NEC CORPORATION, Tokyo (JP)

(21) Appl. No.: 13/823,161

(22) PCT Filed: Sep. 7, 2011
(86) PCT No.: PCT/JP2011/005013

§ 371 Date: Apr. 26, 2013

(30) Foreign Application Priority Data
Nov. 5, 2010 (JP) 2010-248465

(51) Int. Cl. G06T 11/20

(52) U.S. Cl. CPC G06T 11/206
USPC 345/440.1

(57) ABSTRACT

An operation status visualization system visualizes the operation stability of work related to an information system and the status of an operational efficiency at one time. The operation status visualization system includes a graphing means for graphing a safety value and an efficiency value of work related to the information system. One axis on the graph indicates the safety value showing an index of whether the work related to the information system is stably operated. The other axis on the graph indicates the efficiency value showing the operational efficiency of the work related to the information system.

### TECHNICAL FIELD

The present invention relates to an operation status visualization system, an operation status visualization method, and a program.

### BACKGROUND ART

There have been needs for means for allowing a user to easily grasp operation statuses in work on an information system.

For example, Patent Document discloses a cost variation analyzing device that can efficiently set up appropriate prices depending on demand patterns or service levels, that can calculate SLA-relevant unit prices, and that can enable charging based on various service utilization forms and providing of SLA in an IT system in which service demands or service levels temporally vary, for example, by quantitatively evaluating variation risks by mathematically modeling uncertain elements, which temporally vary, and calculating a temporal cash flow for each cost factor.

### RELATED DOCUMENT

### Patent Document

[Patent Document 1] Japanese Laid-open Patent Publication No. 2006-227952

### DISCLOSURE OF THE INVENTION

There is a variety of information representing operation statuses in work on an information system. Accordingly, details which can be grasped by a user greatly differ depending on types of information provided to the user and combinations of information simultaneously provided to the user.

It is thought that users desire to stably work using an information system, that is, to work without being hindered by events such as faults. As means for realizing the desire, for example, means for preventing occurrence of faults by suppressing an operating rate of resources, reducing burdens, and the like, means for avoiding hindrance of work performance due to an occurring fault by redundantly configuring resources, and the like, and means for minimizing an influence of an occurring fault by increasing the number of monitoring operators to rapidly cope with the occurring fault, and the like can be considered.

However, when stabilization of the operation in work on the information system is intended by the use of the above-mentioned means, a cost may increase or resources may not be effectively utilized to lower the operation efficiency in work on the information system.

The inventor thought that there was a user who desires to grasp both of operation stability and operation efficiency in work on the information system having the above-mentioned relations at a time. In the technique disclosed in Patent Document 1, the user cannot grasp the operation stability and the operation efficiency in work on the information system.

Therefore, an object of the invention is to provide means for enabling a user to grasp operation stability and operation efficiency in work on an information system at a time.

According to an aspect of the invention, there is provided an operation status visualization system for visualizing an operation status in work on an information system, including: a graphing unit that takes a stability value, which represents an index on whether the work on the information system can be stably performed, in one axis of a graph, takes an efficiency value, which represents operation efficiency in work on the information system, in the other axis of the graph, and graphs the stability value and the efficiency value in the work on the information system.

According to another aspect of the invention, there is provided a program for visualizing an operation status in work on an information system, causing a computer to serve as: a graphing unit that takes a stability value, which represents an index on whether the work on the information system can be stably performed, in one axis of a graph, takes an efficiency value, which represents operation efficiency in work on the information system, in the other axis of the graph, and graphs the stability value and the efficiency value in the work on the information system.

According to still another aspect of the invention, there is provided an operation status visualization method of visualizing an operation status in work on an information system, including: a graphing step of taking a stability value, which represents an index on whether the work on the information system can be stably performed, in one axis of a graph, taking an efficiency value, which represents operation efficiency in work on the information system, in the other axis of the graph, and graphing the stability value and the efficiency value in the work on the information system.

According to the aspects of the invention, a user can grasp operation stability and operation efficiency in work on an information system at a time.

### BRIEF DESCRIPTION OF THE DRAWINGS

The above-mentioned objects, other objects, features, and advantages of the invention will become more apparent with reference to exemplary embodiments to be described below and the accompanying drawings.

FIG. 1 is a functional block diagram illustrating an example of an operation status visualization system according to an embodiment of the invention.

FIG. 2 is a diagram illustrating the configuration of a stability value calculating unit according to an embodiment of the invention.

FIG. 3 is a diagram illustrating the configuration of a stability value calculating unit according to an embodiment of the invention.

FIG. 4 is a diagram illustrating the configuration of a stability value calculating unit according to an embodiment of the invention.

FIG. 5 is a diagram illustrating the configuration of a stability value calculating unit according to an embodiment of the invention.

FIG. 6 is a diagram illustrating the configuration of a stability value calculating unit according to an embodiment of the invention.

FIG. 7 is a diagram illustrating the configuration of a stability value calculating unit according to an embodiment of the invention.

FIG. 8 is a diagram illustrating the configuration of a stability value calculating unit according to an embodiment of the invention.

FIG. 9 is a diagram illustrating the configuration of a stability value calculating unit according to an embodiment of the invention.

FIG. 10 is a diagram illustrating the configuration of a stability value calculating unit according to an embodiment of the invention.

FIG. 11 is a diagram illustrating the configuration of a stability value calculating unit according to an embodiment of the invention.

FIG. 12 is a diagram illustrating the configuration of a stability value calculating unit according to an embodiment of the invention.

FIG. 13 is a diagram illustrating the configuration of a stability value calculating unit according to an embodiment of the invention.

FIG. 14 is a diagram illustrating the configuration of an efficiency value calculating unit according to an embodiment of the invention.

FIG. 15 is a diagram illustrating the configuration of an efficiency value calculating unit according to an embodiment of the invention.

FIG. 16 is a diagram illustrating the configuration of an efficiency value calculating unit according to an embodiment of the invention.

FIG. 17 is a diagram illustrating the configuration of an efficiency value calculating unit according to an embodiment of the invention.

FIG. 18 is a diagram illustrating the configuration of an efficiency value calculating unit according to an embodiment of the invention.

FIG. 19 is a diagram illustrating the configuration of an efficiency value calculating unit according to an embodiment of the invention.

FIG. 20 is a diagram illustrating the configuration of a graphing unit according to an embodiment of the invention.

FIG. 21 is a diagram illustrating the configuration of a graphing unit according to an embodiment of the invention.

FIG. 22 is a diagram illustrating the configuration of a graphing unit according to an embodiment of the invention.

FIG. 23 is a functional block diagram illustrating an example of an operation status visualization system according to an embodiment of the invention.

FIG. 24 is a diagram illustrating the configuration of a graphing unit according to an embodiment of the invention.

### DESCRIPTION OF EMBODIMENTS

Hereinafter, embodiments of the invention will be described with reference to the accompanying drawings.

An operation status visualization system according to the embodiments is realized by a combination of hardware and software using a CPU of a computer, a memory, a program (which includes a program downloaded from a storage medium such as a CD or a server over Internet, in addition to a program stored in the memory at the time of bringing the system into the market) loaded into the memory, a storage unit such as a hard disk storing the program, and a network interface. It will be understood by those skilled in the art that the realization method and apparatuses can be modified in various forms.

Functional block diagrams used in the description of the embodiments do not show blocks of hardware units but show blocks of functional units. In the drawings, it is shown that each block is realized by a single device, but the realization means thereof is not limited thereto. That is, each block may be a physical block or may be a logical block.

### First Embodiment

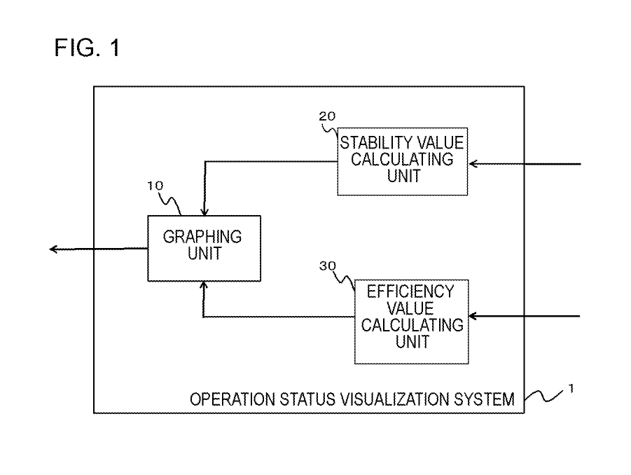

FIG. 1 is a functional block diagram illustrating an example of the configuration of an operation status visualization system 1 according to an embodiment of the invention. The operation status visualization system 1 according to this embodiment shown in FIG. 1 includes a graphing unit 10, a stability value calculating unit 20, and an efficiency value calculating unit 30. The operation status visualization system 1 according to this embodiment and elements of the operation status visualization system 1 will be described in detail below.

The operation status visualization system 1 visualizes operation statuses in work on an information system. The type of work on the information system is not particularly limited, and examples thereof include data center operation, network operation, host operation, and server operation. In this embodiment, it is assumed that the operation status visualization system 1 visualizes operation statuses in work of a “first information system”.

The stability value calculating unit 20 calculates a stability value representing an index on whether work on the first information system can be stably performed. Here, “the work is stably performed” means that the work is performed without being hindered by events such as faults. This is true of the following description.

The stability value may be a value calculated on the basis of at least one of whether occurrence of a fault in the first information system can be prevented, whether preventing of the performance of work due to a fault can he avoided when the fault occurs in the first information system, whether a countermeasure for solving a fault can be rapidly taken when the fault occurs in the first information system, and the history of faults having occurred in the first information system in the past.

More specifically, the stability value may be a value calculated on the basis of at least one of a status in which a service level provided by the first information system lowers, utilization efficiency of resources of the first information system, a degree of introduction of a redundant configuration into the first information system, a status in which heat-trapping occurs in a space in which the first information system is disposed, a status in which risk prediction training in the work on the first information system is performed, the number of monitoring operators who monitor the work on the first information system, and consecutive work time of the monitoring operators. Specific Examples (1) to (6) where the stability value calculating unit 20 calculates the stability value will be described in detail below.

(1) First, an example where the stability value calculating unit 20 calculates a stability value (X1) on the basis of a status in which a service level provided by the first information system lowers will be described below. In this example, the stability value calculating unit 20 calculates the stability value (X1) on the basis of a status in which a violation of an SLA occurs. More specifically, the stability value calculating unit 20 calculates a stability value representing that as the violation occurrence frequency of the SLA becomes larger, the work on the first information system cannot be performed less stably. An example where the stability value calculating unit calculates such a stability value will be described below.

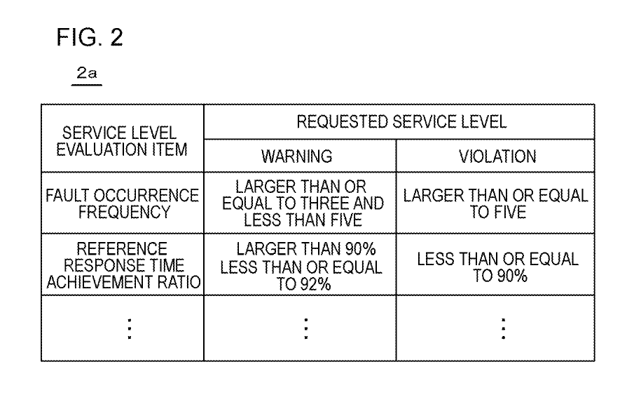

The stability value calculating unit 20 stores information representing service level evaluation items defined in the SLA determined for the work on the first information system and requested service levels. For example, the stability value calculating unit 20 may store the SLA definition table 2a shown in FIG. 2.

In the SLA definition table 2a shown in FIG. 2, there is a section in which service level evaluation items defined in the SLA are recorded. The service level evaluation items are not particularly limited, and a fault occurrence frequency in a predetermined period, a reference response time achievement ratio in a predetermined period, and the like can be used, for example, as shown in the drawing. The reference response time achievement ratio is defined as a ratio of the number of transactions responding in the reference response time to the total number of transactions in the predetermined period. The predetermined period is a designable factor and all periods such as one day, one week, ten days, one month, six months, and one year can be used. This premise is true of all the predetermined periods in the following description. The reference response time is also a designable factor.

In the SLA definition table 2a shown in FIG. 2, there is a section in which requested service levels are recorded in correlation with the service level evaluation items. The requested service levels define the violations of the SLA. The method of setting the requested service levels is not particularly limited, but two levels may be set for each service level evaluation item, for example, as shown in the drawing. In the example shown in the drawing, the level of “violation” representing a state where the service level is markedly low and the level of “warning” representing a state where the service level does not reach the level of “violation” but is low are set as the violation of the SLA. Specifically, when the fault occurrence frequency in a predetermined period is larger than or equal to three and less than five, the service level is set to the level of “warning”. When the fault occurrence frequency in the predetermined period is larger than or equal to five, the service level is set to the level of “violation”. When the reference response time achievement ratio in a predetermined period is larger than 90% and lower than or equal to 92%, the service level is set to the level of “warning”. When the reference response time achievement ratio in the predetermined period is lower than or equal to 90%, the service level is set to the level of “violation”.

The number of levels to be set as the requested service level may be one or may be larger than or equal to three. Hereinafter, it is assumed that the requested service level is set to one of the level of “violation” and the level of “warning”, as shown in the SLA definition table 2a of FIG. 2. The specific numerical values of the requested service level defined in the SLA are riot particularly limited, and the numerical values shown in the SLA definition table 2a of FIG. 2 are only examples. For example, the SLA definition table 2a may be prepared in advance by a user and may be stored in the stability value calculating unit 20.

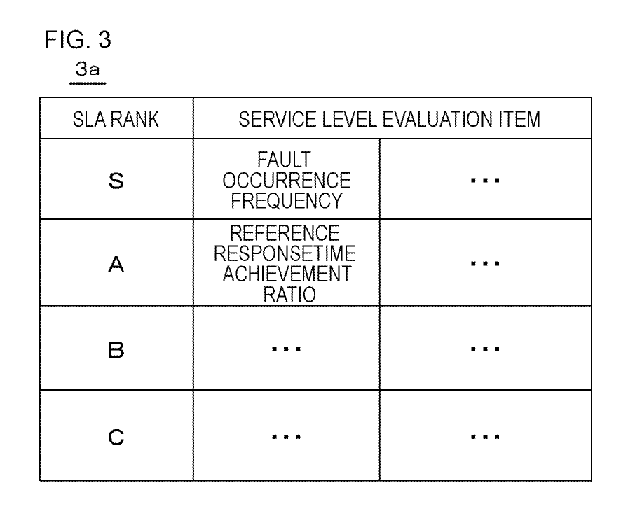

The stability value calculating unit 20 is configured to he able to use information in which the service level evaluation items defined in the SLA are ranked on the basis of the degree of influence on performance stability of the work (hereinafter, referred to as “work performance stability”) on the first information system. For example, the stability value calculating unit 20 may store an evaluation item ranking table 3a as shown in FIG. 3. In the evaluation item ranking table 3a, each service level evaluation item defined in the SLA includes four ranks of S, A, B, and C. Here, it is assumed that the service level evaluation item belonging to rank S has the largest influence on the work performance stability, and the influence becomes smaller in the order of ranks A, B, and C.

The ranking of the service level evaluation items can be determined by a user, for example, on the basis of details of the service level evaluation items. The number of ranks is a designable factor. For example, the evaluation item ranking table 3a may be prepared in advance by a user and stored in the stability value calculating unit 20.

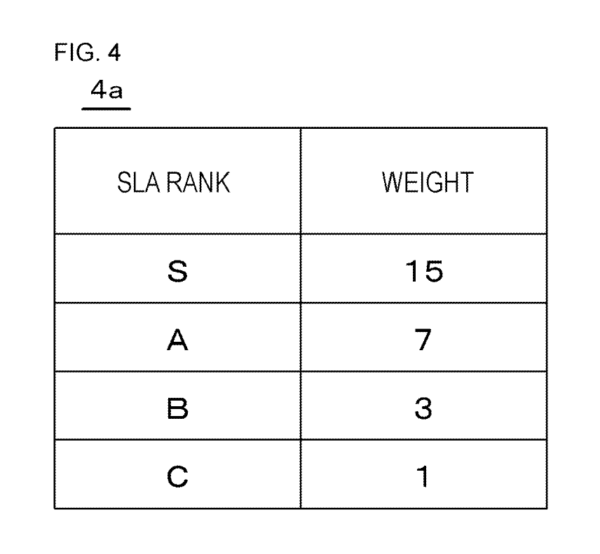

The stability value calculating unit 20 is configured to be able to use information representing weighting values determined depending on the degree of influence on the work performance stability for each rank. For example, the stability value calculating unit 20 may store a rank weighting table 4a as shown in FIG. 4. In the rank weighting table 4a, the weighting value is recorded in a section of “weight”.

The specific weighting values set for the ranks are designable factors and can be determined, for example, by a user. For example, the rank weighting table 4a may be prepared in advance by a user and may be stored in the stability value calculating unit 20.

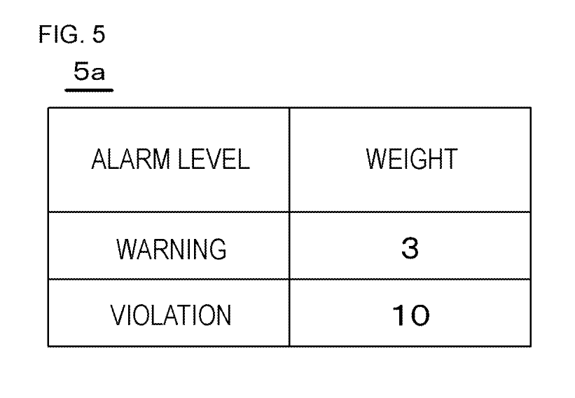

The stability value calculating unit 20 is configured to be able to use information representing weighting values determined depending on the degree of influence on the work performance stability for the service levels (“warning” and “violation”) set to the requested service level. For example, the stability value calculating unit 20 may store a service level weighting table 5a in which the weighting values of the level of “warning” and the level of “violation” are recorded as shown in FIG. 5. In the service level weighting table 5a, the weighting values are described in a section of “weight”. The specific weighting values correlated with the service levels are designable factors and can be determined, for example, by a user. For example, the service level weighting table 5a may be prepared in advance by a user and may be stored in the stability value calculating unit 20.

The stability value calculating unit 20 acquires historical data of the service level evaluation items. The historical data is data used to evaluate the service level evaluation items. For example, the historical data of the service level evaluation item of “fault occurrence frequency” is data used to calculate the fault occurrence frequency in a predetermined period, and the historical data of the service level evaluation item of “reference response time achievement ratio” is data used to calculate the reference response time achievement ratio in a predetermined period. Means for enabling the stability value calculating unit 20 to acquire the historical data of the service level evaluation items can be embodied according to the related art and thus description thereof will not be repeated herein.

The stability value calculating unit 20 calculates the “warning” level occurrence frequency and the “violation” level occurrence frequency for each service level evaluation item in a predetermined period using the acquired historical data and the SLA definition table 2a shown in FIG. 2. Means for enabling the stability value calculating unit 20 to compare the historical data with a predetermined level and to calculate the service level occurrence frequencies can be embodied according to the related art and thus description thereof will not be repeated herein.

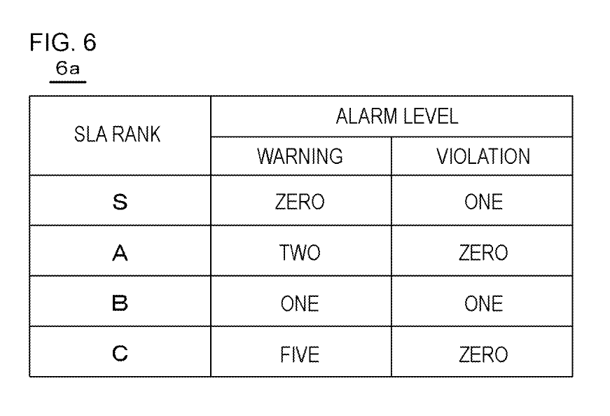

The stability value calculating unit 20 calculates the total number of “warning” levels occurring and the total number of “violation” levels occurring in a predetermined time for one or more service level evaluation items belonging to the corresponding rank for each rank of the service level evaluation items using the calculation result and the evaluation item ranking table 3a shown in FIG. 3. The stability value calculating unit 20 may record the calculation result, for example, in a rank alarm level table 6a as shown in FIG. 6 and may store the table.

Thereafter, the stability value calculating unit 20 calculates the stability value (X1) on the basis of a predetermined computing expression using the rank weighting table 4a (see FIG. 4), the service level weighting table 5a (see FIG. 5), and the rank alarm level table 6a (see FIG. 6).

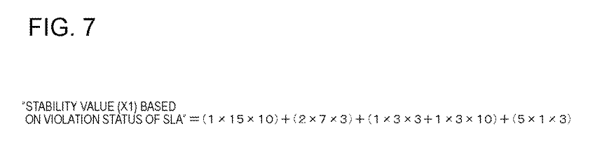

An example of the computing expression is shown in FIG. 7. The first term on the right side of the expression shown in FIG. 7 represents a value which is relevant to rank S and which is obtained by multiplying the “violation” level occurrence frequency “1” (see FIG. 6) by the weighting value “15” of rank S (see FIG. 4) and the weighting value “10” of “violation” (see FIG. 5). The second term represents a value which is relevant to rank A and which is obtained by multiplying the “warning” level occurrence frequency “2” (see FIG. 6) by the weighting value “7” of rank A (see FIG. 4) and the weighting value “3” of “warning” (see FIG. 5). The third term represents a value which is relevant to rank B and which is obtained by adding a value obtained by multiplying the “warning” level occurrence frequency “1” (see FIG. 6) for rank B by the weighting value “3” of rank B (see FIG. 4) and the weighting value “3” of “warning” (see FIG. 5) to a value obtained by multiplying the “warning” level occurrence frequency “1” (see FIG. 6) by the weighting value “3” of rank B (see FIG. 4) and the weighting value “10” of “violation” (see FIG. 5). The fourth term represents a value which is relevant to rank C and which is obtained by multiplying the “warning” level occurrence frequency “5” (see FIG. 6) by the weighting value “1” of rank C (see FIG. 4) and the weighting value “3” of “warning” (see FIG. 5).

In the computing expression shown in FIG. 7, the sum value of the terms on the right side is the stability value (X1) calculated on the status in which the violation of SLA occurs. The stability value (X1) calculated in this way means that the smaller the value is, the more stably the work on the first information system can be performed and that the larger the value is, the less stably the work can be performed.

In the above description, two requested service levels (“violation” and “warning”) are set and the stability value (X1) is calculated using the service level occurrence frequency, but more requested levels may be set and the level occurrence frequencies thereof may be used to calculate the stability value (X1). Only one requested level may be set and only the level occurrence frequency may be used to calculate the stability value (X1).

In the above description, the stability value (X1) is calculated using the service level occurrence frequencies, but the stability value (X1) may be calculated in the same manner as described above, except that the total time in which each service level is maintained is used instead of the occurrence frequency. Means for calculating the total time in which each service level is maintained can be embodied according to the related art and thus description thereof will not be repeated herein.

(2) Then, an example where the stability value calculating unit 20 calculates a stability value (X2) on the basis of utilization efficiency of resources of the first information system will be described below. In this example, the stability value calculating unit 20 calculates a stability value representing that as the utilization efficiency of resources of the first information system becomes higher, the work on the first information system cannot be performed less stably. An example where the stability value calculating unit calculates such a stability value will be described below.

Resources to be described below include devices having a CPU as elements essential for realizing functions, such as servers or virtual machines.

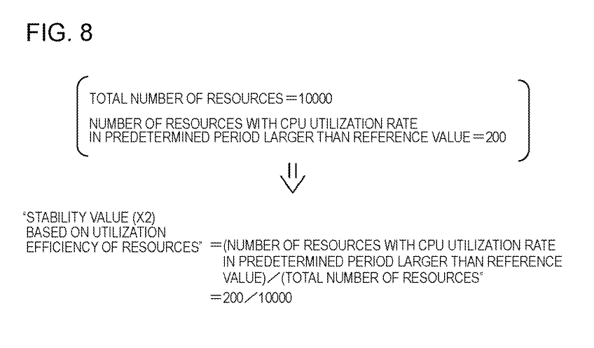

The stability value calculating unit 20 may calculate as the stability value (X2) a value obtained by dividing the number of resources of which the CPU utilization rate in a predetermined period is larger by a predetermined value than a reference value (designable factor) out of all resources of the first information system by the number of all the resources (the total number of resources) of the first information system, for example, as shown in FIG. 8. The stability value (X2) calculated in this way means that the smaller the value is, the more stably the work on the first information system can be performed and that the larger the value is, the less stably the work can be performed.

Means for enabling the stability value calculating unit 20 to acquire information representing the total number of resources is not particularly limited, but for example, the stability value calculating unit 20 may acquire the information representing the total number of resources by receiving an input from a user. Means for enabling the stability value calculating unit 20 to acquire information representing the number of resources of which the CPU utilization rate in a predetermined period is larger by a predetermined value than the reference value is not particularly limited, but for example, the stability value calculating unit 20 may acquire the information representing the number of resources of which the CPU utilization rate is larger by a predetermined than the reference value, by storing information representing the reference value in advance, monitoring whether the CPU utilization rate of each of the plural resources is larger than the reference value, and counting the frequency in which the CPU utilization rate is larger than the reference value for each resource.

The stability value calculating unit 20 may calculate the stability value (X2) according to other modification examples based on the above-mentioned configuration. For example, the count of the frequency may be set to “1” when the CPU utilization rate is larger than the reference value consecutively for a predetermined time (designable factor).

The following examples can be considered as the other modification examples. The stability value calculating unit 20 calculates the time in which the state where the CPU utilization rate is larger than the reference value (designable factor) is maintained in a predetermined period for each of all the resources of the first information system, and calculates the total time (total reference value excess time) thereof. The stability value calculating unit 20 calculates the operation time of each of all the resources of the first information system in a predetermined period and calculates the total time (total operation time) thereof. The stability value calculating unit 20 may calculate as the stability value (X2) a value obtained by dividing the total reference value excess time by the total operation time. The stability value (X2) calculated in this way means that the smaller the value is, the more stably the work on the first information system can be performed and that the larger the value is, the less stably the work can be performed.

(3) Then, an example where the stability value calculating unit 20 calculates a stability value (X3) on the basis of a status where heat-trapping occurs in a space in which the first information system is disposed will be described below. In this example, the stability value calculating unit 20 calculates a stability value representing that as the heat-trapping occurrence frequency becomes larger, the work on the first information system cannot be performed less stably. An example where the stability value calculating unit calculates such a stability value will be described below.

Here, the space in which the first information system is disposed means a space (hereinafter, referred to as a “system space”) in which the resources of the first information system are disposed.

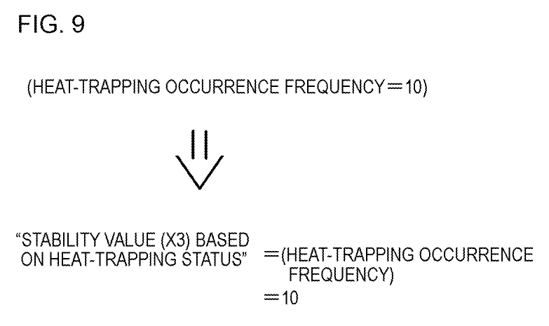

The stability value calculating unit 20 may calculate as the stability value (X3) the heat-trapping occurrence frequency in the system space in a predetermined period, for example, as shown in FIG. 9. The stability value (X3) calculated in this way means that the smaller the value is, the more stably the work on the first information system can be performed and that the larger the value is, the less stably the work can be performed.

Means for enabling the stability value calculating unit 20 to calculate the heat-trapping occurrence frequency is not particularly limited, but the heat-trapping occurrence frequency can be calculated using all the techniques according to the related art. For example, the stability value calculating unit 20 may monitor the temperature state of the entire system space and may count the heat-trapping occurrence frequency in accordance with the following two rules.

(Rule 1) When there is a place in the system space of which the temperature is changed from below a predetermined temperature (designable factor) to above the predetermined temperature, “1” is counted up.

(Rule 2) when there are two separated places of which the temperature is changed from below a predetermined temperature to above the predetermined temperature, “2” is counted up.

The rules are only examples, and the stability value calculating unit 20 may count the heat-trapping occurrence frequency in accordance with other rules. Means for enabling the stability value calculating unit 20 to monitor the temperature state of the entire system space can be embodied according to the related art and thus description thereof will not be repeated herein.

The stability value calculating unit 20 may calculate the stability value (X3) according to other modification examples based on the above-mentioned configuration. For example, the stability value calculating unit 20 stores information representing a weighting value determined for each subspace which is obtained by dividing the entire system space into plural subspaces. Then, the stability value calculating unit 20 may calculate the stability value (X3) the total sum of values obtained by multiplying the heat-trapping occurrence frequency for each subspace in a predetermined period by the weighting value determined for the subspace.

The weighting value determined for each subspace is a designable factor and can be determined depending on the degree of influence on the work performance stability. For example, it is thought that a subspace in which a resource essential to the work performance has a high degree of influence on the work performance stability and a subspace in which plural redundant resources are disposed has a low degree of influence on the work performance stability. The weighting value determined for each subspace can be determined, for example, by a user under such thought. Means for dividing the system space into subspaces is a designable factor and can be determined, for example, by a user.

(4) Then, an example where the stability value calculating unit 20 calculates a stability value (X4) on the basis of the degree of introduction of a redundant configuration into the first information system will be described below.

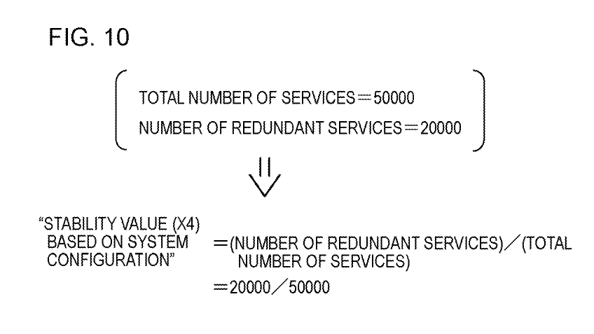

The stability value calculating unit 20 may calculates as the stability value (X4) a value obtained by dividing the number of services provided through the use of redundant resources out of all the services provided by the first information system by the number of all the services (the total number of services) provided by the first information system, for example, as shown in FIG. 10. The stability value (X4) calculated in this way means that the smaller the value is, the more stably the work on the first information system can be performed and that the larger the value is, the less stably the work can be performed.

The stability value calculating unit 20 may acquire the information representing the total number of services and the number of services provided through the use of the redundant resources, for example, by receiving an input from a user.

(5) Then, an example where the stability value calculating unit 20 calculates a stability value (X5) on the basis of the status in which risk prediction training for performance of the work on the first information system is performed, the number of monitoring operators monitoring the performance of the work on the first information system, and the consecutive work time of the monitoring operators will be described below.

In this example, the stability value calculating unit 20 calculates a stability value representing that as the smaller the risk prediction training frequency for the performance of the work on the first information system is, the less stably the work on the first information system is performed. The stability value calculating unit 20 calculates a stability value representing that as the smaller the number of monitoring operators who monitors the performance of the work on the first information system is, the less stably the work on the first information system is performed. The stability value calculating unit 20 calculates a stability value representing that as the longer the consecutive work time of the monitoring operators is, the less stably the work on the first information system is performed. An example where the stability value calculating unit calculates such a stability value will be described.

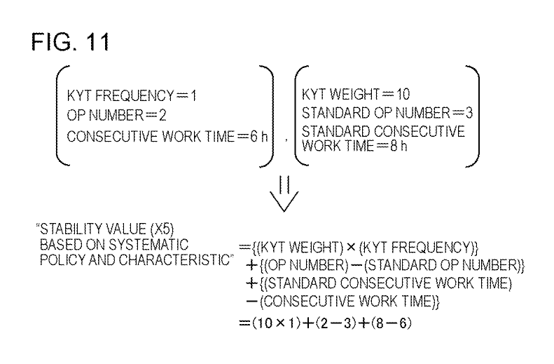

The stability value calculating unit 20 stores information representing weighting values determined depending on the degree of influence of the risk prediction training frequency on the work performance stability, for example, as shown in FIG. 11 (“KYT WEIGHT” in the drawing). Details of the risk prediction training are a designable factor.

The stability value calculating unit 20 stores information representing a standard value (“STANDARD OP NUMBER” in the drawing) of the number of monitoring operators who monitor the performance of the work on the first information system. Here, the number of monitoring operators can be said to be, for example, the number of monitoring operators who are simultaneously engaged in the monitoring work. The standard OP number may be the number of monitoring operators who can rapidly discover abnormality of the first information system. The standard OP number is a designable factor, may be prepared in advance, for example, by a user, and may be stored in the stability value calculating unit 20.

The stability value calculating unit 20 stores information representing the standard work time (“STANDARD CONSECUTIVE WORK TIME” in the drawing) in which the monitoring operators who consecutively monitor the performance of the work on the first information system. The standard consecutive work time may be a time in which a monitoring operator can keep concentration, that is, a time in which a monitoring operator can rapidly discover abnormality of the first information system. The standard consecutive work time is a designable factor, may be determined in advance, for example, by a user, and may be stored in the stability value calculating unit 20.

The stability value calculating unit 20 acquires information representing the risk prediction training frequency (“KYT FREQUENCY” in the drawing) performed in a predetermined period, the average number of monitoring operators (“OP NUMBER” in the drawing) who are simultaneously engaged in the monitoring work, and the average time (“CONSECUTIVE WORK TIME” in the drawing) in which the monitoring operators who are engaged in the monitoring work in a predetermined period consecutively perform the monitoring work, by receiving an input from a user.

The stability value calculating unit 20 calculates the stability value (X5) on the basis of a predetermined computing expression using the information.

An example of the computing expression is shown in FIG. 11. The first term on the right side of the expression shown in FIG. 11 represents a value which is relevant to the status in which the risk prediction training for the performance of the work on the first information system is performed and which is obtained by multiplying the “KYT frequency” by the “KYT weight”. The second term is a value which is relevant to the number of monitoring operators who monitor the performance of the work on the first information system and which is obtained by subtracting the “standard OP number” from the “OP number”. The third term is a value which is relevant to the consecutive work time of the monitoring operators and which is obtained by subtracting the “consecutive work time” from the standard consecutive work time”.

In the computing expression shown in FIG. 11, the sum of the terms on the right side is the stability value (X5). The stability value (X5) calculated in this way means that the larger the value is, the more stably the work on the first information system can be performed and that the smaller the value is, the less stably the work can be performed.

The stability value calculating unit 20 may calculate the stability value (X5) according to other modification examples based on the above-mentioned configuration. For example, the stability value calculating unit 20 may calculate the stability value (X5) in the same manner as described above, without using at least one of the status in which the risk prediction training in the performance of the work on the first information system is performed, the number of monitoring operators who monitor the performance of the work on the first information system, and the consecutive work time of the monitoring operators.

(6) Then, an example where the stability value calculating unit 20 calculates a stability value using at least two of the stability values (X1 to X5) calculated as described above. An example where the stability value calculating unit 20 calculates a stability value (X) using all the stability values (X1 to X5) calculated as described above will be described below.

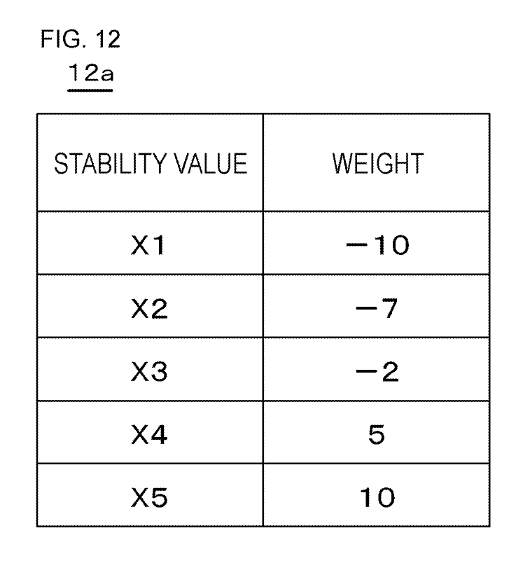

The stability value calculating unit 20 is configured to be able to use information representing weighting values determined depending on the degree of influence on the work performance stability for each of the stability values (X1 to X5). For example, the stability value calculating unit 20 may store a weighting table 12a as shown in FIG. 12. In the weighting table 12a, the weighting values are recorded in a section of “weight”.

The specific weighting values correlated with the stability values (X1 to X5) are designable factors and can be determined, for example, by a user. For example, the weighting table 12a may be prepared in advance by a user and may be stored in the stability value calculating unit 20.

Here, as described in examples (1) to (5), some of the stability values (X1 to X5) represent that the larger the value is, the larger the stability is, and some stability values represent that the smaller the value is, the larger the stability is. Therefore, for the purpose of unifying the directions, minus values are determined as the weighting values of the stability values (X1 to X5) in the weighting table 12a.

The stability value calculating unit 20 calculates the stability value (X) on the basis of a predetermined computing expression using the stability values (X1 to X5) calculated through the use of means described in examples (1) to (5) and the weighting table 12a.

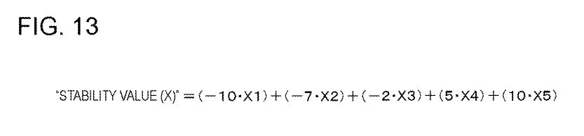

An example of the computing expression is shown in FIG. 13. The first term on the right side of the expression shown in FIG. 13 is a value obtained by multiplying the weighting value “−−10” (see FIG. 12) correlated with the stability value (X1) by the stability value (X1). The second term is a value obtained by multiplying the weighting value “−7” (see FIG. 12) correlated with the stability-value (X2) by the stability value (X2). The third term is a value obtained by multiplying the weighting value “−2” (see FIG. 12) correlated with the stability value (X3) by the stability value (X3). The fourth term is a value obtained by multiplying the weighting value “5” (see FIG. 12) correlated with the stability value (X4) by the stability value (X4). The fifth term is a value obtained by multiplying the weighting value “10” (see FIG. 12) correlated with the stability value (X5) by the stability value (X5).

In the computing expression shown in FIG. 13, the sum of the terms on the right side is the stability value (X). The stability value (X) calculated in this way means that the larger the value is, the more stably the work on the first information system can be performed and that the smaller the value is, the less stably the work can be performed.

Referring to FIG. 1 again, the efficiency value calculating unit 30 calculates an efficiency value representing the operation efficiency of the work on the first information system.

The efficiency value is, for example, a value calculated on the basis of at least one of the operation cost of the first information system and the utilization efficiency of resources of the first information system.

More specifically, the efficiency value may be a value calculated on the basis of at least one of utilization efficiency of resources of the first information system, power consumption of the first information system, the number of times in which a monitoring operator who monitors the performance of the work on the first information system calls another person in relation to the performance of the work on the first information system, a period of time until a fault in the work on the first information system is restored after the fault occurs, and a period of time until a predetermined countermeasure against a fault in the work on the first information system is started after the fault occurs. Specific examples (1) to (4) in which the efficiency value calculating unit 30 calculates the efficiency value will be described below.

(1) First, an example where the efficiency value calculating unit 30 calculates an efficiency value (Y1) on the basis of the utilization efficiency of resources of the first information system will be described below. In this example, the stability value calculating unit 20 calculates an efficiency value representing that as the utilization efficiency of resources of the first information system becomes higher, the operation efficiency of the first information system becomes higher. An example where the stability value calculating unit calculates the efficiency value will be described below. The concept of resources is the same as described above.

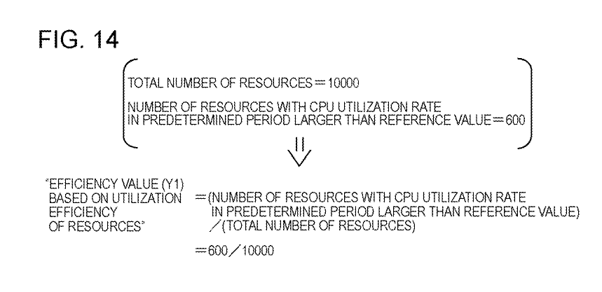

The efficiency value calculating unit 30 may calculate as the efficiency value (Y1) a value obtained by dividing the number of resources of which the CPU utilization rate in a predetermined period is larger by a predetermined value (designable factor) than a reference value (designable factor) out of all the responses of the first information system by the number of all resources (the total number of resources) of the first information system, for example, as shown in FIG. 14. The efficiency value (Y1) calculated in this way means that the larger the value is, the more stably the work on the first information system can be performed and that the smaller the value is, the less stably the work can be performed.

Means for enabling the efficiency value calculating unit 30 to acquire information representing the total number of resources and means for enabling the efficiency value calculating unit to acquire information representing the number of resources of which the CPU utilization rate in a predetermined period is larger by a predetermined value than the reference value are not particularly limited, but can be embodied by the same means as embodying the stability value calculating unit 20.

The efficiency value calculating unit 30 may calculate the efficiency value (Yl) according to other modification examples based on the above-mentioned configuration. For example, the count of the predetermined frequency may be set to “1” when the CPU utilization rate is larger than the reference value consecutively for a predetermined time (designable factor).

The following examples can be considered as the other modification examples. The efficiency value calculating unit 30 calculates the time in which the state where the CPU utilization rate is larger than the reference value (designable factor) is maintained in a predetermined period for each of all the resources of the first information system, and calculates the total time (total reference value excess time) thereof. The efficiency value calculating unit 30 calculates the operation time of each of all the resources of the first information system in a predetermined period and calculates the total time (total operation time) thereof. The efficiency value calculating unit 30 may calculate as the efficiency value (Y1) a value obtained by dividing the total reference value excess time by the total operation time. The efficiency value (Y1) calculated in this way means that the larger the value is, the higher the operation efficiency of the work on the first information system is and that the smaller the value is, the lower the operation efficiency is.

(2) An example where the efficiency value calculating unit 30 calculates an efficiency value (Y2) on the basis of the power consumption of the first information system will be described below. In this case, the stability value calculating unit 20 calculates an efficiency value representing that the smaller the power consumption is, the higher the operation efficiency of the first information system is. An example where the stability value calculating unit calculates such an efficiency value will be described below.

First, the efficiency value calculating unit 30 calculates DCiE of the first information system in a predetermined period DCiE is an index indicating the energy efficiency of a data center or the like and can be defined as a ratio of the energy consumption in an IT device such as a server or a network device to the total energy consumption in the data center. Means for enabling the efficiency value calculating unit 30 to acquire data used to calculate the DCiE (%) and calculation means using the data are not particularly limited, can be embodied according to the related art, and thus description thereof will not be repeated herein.

The efficiency value calculating unit 30 acquires information representing air-conditioning power in normal in a system space in which resources of the first information system are disposed and air-conditioning power in supercooling. Here, “normal” means a state where a problem in temperature such as heat-trapping does not occur in the system space. “Supercooling” means a state other than the normal state and specifically means a state where a problem in temperature such as heat-trapping occurs in the system space and the system space is cooled more strongly than in the normal state.

The efficiency value calculating unit 30 can determine a time zone of the “normal state” and a time zone of the “supercooling state” in a predetermined period, for example, depending on the strength of the air-conditioning, and can calculate power consumption (kWh) of each time zone. Means for enabling the efficiency value calculating unit 30 to acquire the information representing the power consumption (kWh) in the predetermined period can be embodied according to the related art and thus description thereof will not be repeated.

The efficiency value calculating unit 30 calculates the efficiency value (Y2) on the basis of a predetermined computing expression using the information acquired as described above.

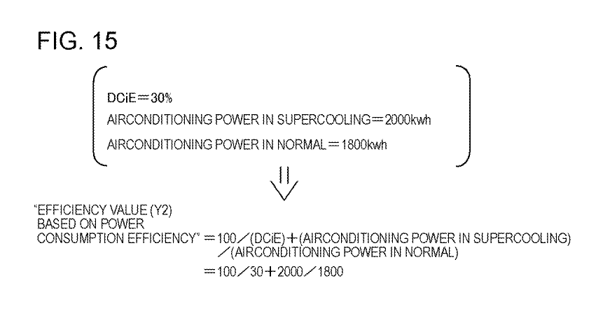

An example of the computing expression is shown in FIG. 15. The first term on the right side of the expression shown in FIG. 15 represents a value which is relevant to DCiE and which is obtained by dividing “100 by DCiE (%). The second term represents a value which is relevant to the air-conditioning power and which is obtained by dividing the air-conditioning power in supercooling by the air-conditioning power in normal. In the computing expression shown in FIG. 15, the sum of the values of the terms on the right side is the efficiency value (Y2). The efficiency value (Y2) calculated in this way means that as the smaller the value is, the higher the operation efficiency of the work on the first information system is and that the larger the value is, the lower the operation efficiency of the work on the first information system is.

The efficiency value calculating unit 30 may calculate the efficiency value (Y2) according to other modification examples based on the above-mentioned configuration. For example, the power consumption is expressed in the unit of “kWh” above, but the power consumption may be expressed in terms of “yen”, that is, the amount of money to be paid to an electric power company, and the efficiency value (Y2) may be calculated otherwise as described above. The total times in the supercooling state and the normal states in a predetermined period may be used instead of the air-conditioning powers in supercooling and in normal and the efficiency value (Y2) may be calculated otherwise as described above.

(3) An example where the efficiency value calculating unit 30 calculates an efficiency value (Y3) on the basis of the number of times in which a monitoring operator monitoring the performance of the work on the first information system calls out another person in relation to the performance of the work on the first information system, the period of time until a fault in the work on the first information system is restored after the fault occurs, and the period of time until a predetermined countermeasure against a fault in the work on the first information system is started after the fault occurs.

In this example, the efficiency value calculating unit 30 calculates an efficiency value representing that as the number of times in which a monitoring operator monitoring the performance of the work on the first information system calls out another person in relation to the performance of the work on the first information system is smaller, the operation efficiency of the first information system is higher. The efficiency value calculating unit 30 calculates an efficiency value representing that as the period of time until a fault in the work on the first information system is restored after the fault occurs is shorter, the operation efficiency of the first information system is higher. The efficiency value calculating unit 30 calculates an efficiency value representing that as the period of time until a predetermined countermeasure against a fault in the work on the first information system is started after the fault occurs is shorter, the operation efficiency of the first information system is higher. An example where the efficiency value calculating unit 30 calculates such efficiency values will be described below.

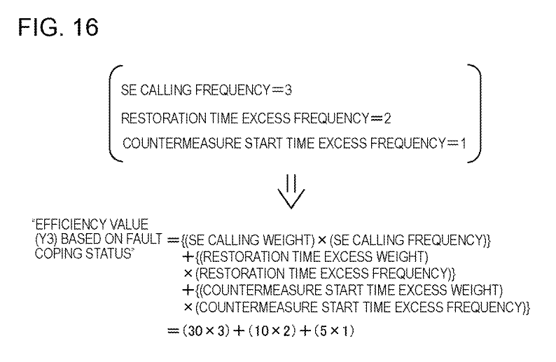

The efficiency value calculating unit 30 acquires information (“SE calling frequency” in FIG. 16) the number of times in which a monitoring operator monitoring the performance of the work on the first information system calls out another person in relation to the performance of the work on the first information system. The efficiency value calculating unit 30 can acquire such information, for example, by receiving an input form a user.

The number of times in which a monitoring operator monitoring the performance of the work on the first information system calls out another person in relation to the performance of the work on the first information system means the number of times in which, for example, a system engineer (SE), a manager, or a person of a predetermined department is called out when a problem occurs in the first information system and this problem cannot be solved by the monitoring operator. Whom to call out is a designable factor, but it is assumed herein that the SE is called out.

The efficiency value calculating unit 30 acquires information (“restoration time excess frequency” in FIG. 16) representing the fault occurrence frequency in which the time until a fault occurring in a predetermined time is restored after the fault occurs is longer than a predetermined time (designable factor). The efficiency value calculating unit 30 can acquire such information, for example, by receiving an input form a user.

The efficiency value calculating unit 30 acquires information (“countermeasure start time excess frequency” in FIG. 16) representing the fault occurrence frequency in which the time until a user or a predetermined system starts a predetermined countermeasure against a fault occurring in a predetermined period after the fault occurs is longer than a predetermined time (designable factor).

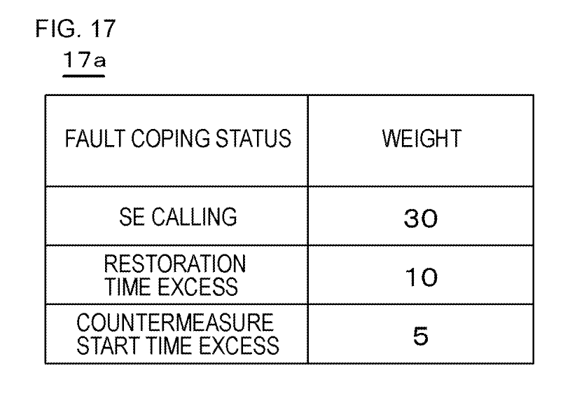

The efficiency value calculating unit 30 is configured to be able to use information representing weighting values determined depending on the degree of influence on the operation efficiency of the work on the first information system for each of the SE calling frequency, the restoration time excess frequency, and the countermeasure start time excess frequency (hereinafter, collectively referred to as “fault correspondence”). For example, the efficiency value calculating unit 30 may store a fault-correspondence weighting table 17a shown in FIG. 17. In the fault-correspondence weighting table 17a, the weighting values are recorded in a section of “weight”.

The specific weighting value set in correspondence with each fault is a designable factor and can be determined, for example, by a user. For example, the above-mentioned fault-correspondence weighting table 17a may be prepared in advance by a user and may be stored in the efficiency value calculating unit 30.

The efficiency value calculating unit 30 calculates the efficiency value (Y3) on the basis of a predetermined computing expression using the information acquired as described above.

An example of the computing expression is shown in FIG. 16. The first term on the right side of the expression shown in FIG. 16 represents a value which is relevant to the SE calling frequency and which is obtained by multiplying the SE calling frequency (see FIG. 16) by the weighting value “30” of the SE calling (see FIG. 17). The second term represents a value which is relevant to the restoration time excess frequency and which is obtained by multiplying the restoration time excess frequency (see FIG. 16) by the weighting value “10” of the restoration time excess (see FIG. 17). The third term represents a value which is relevant to the countermeasure start time excess frequency and which is obtained by multiplying the countermeasure start time excess frequency (see FIG. 16) by the weighting value “5” of the countermeasure start time excess (see FIG. 17).

In the computing expression shown in FIG. 16, the sum of the values of the terms on the right side is the efficiency value (Y3). The efficiency value (Y3) calculated in this way means that as the smaller the value is, the higher the operation efficiency of the work on the first information system is and that the larger the value is, the lower the operation efficiency of the work on the first information system is.

The efficiency value calculating unit 30 may calculate the efficiency value (Y3) according to other modification examples based on the above-mentioned configuration. For example, the efficiency value calculating unit 30 may calculate the efficiency value (Y3) as described above otherwise without using at least one of the number of times in which a monitoring operator monitoring the performance of the work on the first information system calls out another person in relation to the performance of the work on the first information system, a period of time until a fault in the work on the first information system is restored after the fault occurs, and a period of time until a predetermined countermeasure against a fault in the work on the first information system is started after the fault occurs.

(4) An example where the efficiency value calculating unit 30 calculates an efficiency value (Y) using at least two of the efficiency values (Y1 to Y3) calculated as described above will be described below. An example where the efficiency value calculating unit 30 calculates the efficiency value (Y) using all the efficiency values (Y1 to Y3) calculated as described above will be described below.

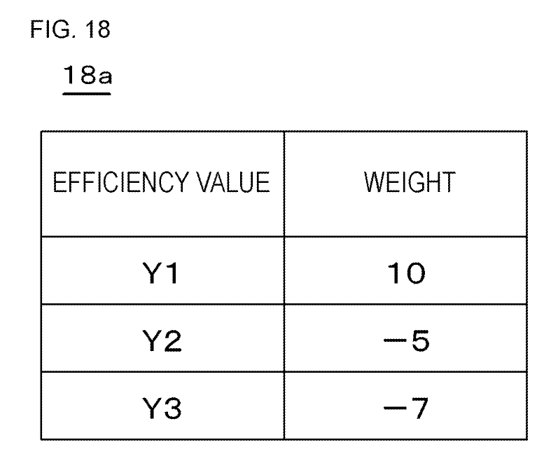

The efficiency value calculating unit 30 is configured to be able to use information representing weighting values depending on the degree of influence on the operation efficiency of the work on the first information system for each efficiency value (Y1 to Y3). For example, the efficiency value calculating unit 30 may store a second weighting table 18a shown in FIG. 18. In the second weighting table 18a, the weighting values are recorded in a section of “weight”.

The specific weighting value correlated with each efficiency value (Y1 to Y3) is a designable factor and can be determined, for example, by a user. For example, the second weighting table 18a may be prepared in advance by a user and may be stored in the efficiency value calculating unit 30.

Here, as described in examples (1) to (3), some of the efficiency values (Y1 to Y3) represent that the larger the value is, the higher the operation efficiency is, and some efficiency values represent that the smaller the value is, the higher the operation efficiency is. Therefore, for the purpose of unifying the directions, minus values are determined as the weighting values of the efficiency values (Y1 to Y3) in the second weighting table 18a.

The efficiency value calculating unit 30 calculates the efficiency value (Y) on the basis of a predetermined computing expression using the efficiency values (Y1 to Y3) calculated in examples (1) to (3) and the second weighting table 18a.

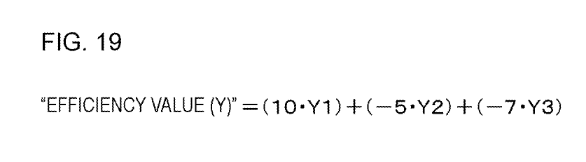

An example of the computing expression is shown in FIG. 19. The first term on the right side of the expression shown in FIG. 19 represents a value obtained by multiplying the efficiency value (Y1) by the weighting value “10” (see FIG. 18) determined for the efficiency value (Y1). The second term represents a value obtained by multiplying the efficiency value (Y2) by the weighting value “−5” (see FIG. 18) determined for the efficiency value (Y2). The third term represents a value obtained by multiplying the efficiency value (Y3) by the weighting value “−7” (see FIG. 18) determined for the efficiency value (Y3).

In the computing expression shown in FIG. 19, the sum of the terms on the right side is the efficiency value (Y). The efficiency value (Y) calculated in this way means that the larger the value is, the higher the operation efficiency of the work on the first information system is and that the smaller the value is, the lower the operation efficiency is.

Referring to FIG. 1 again, the graphing unit 10 displays the stability value and the efficiency value of the first information system in a graph by setting one axis of the graph to the stability value and setting the other axis of the graph to the efficiency value. The graphing unit 10 can display the graph using the stability value calculated by the stability value calculating unit 20 and the efficiency value calculated by the efficiency value calculating unit 30. The graphing unit 10 outputs an image of the graph using all output units such as a display and a printer.

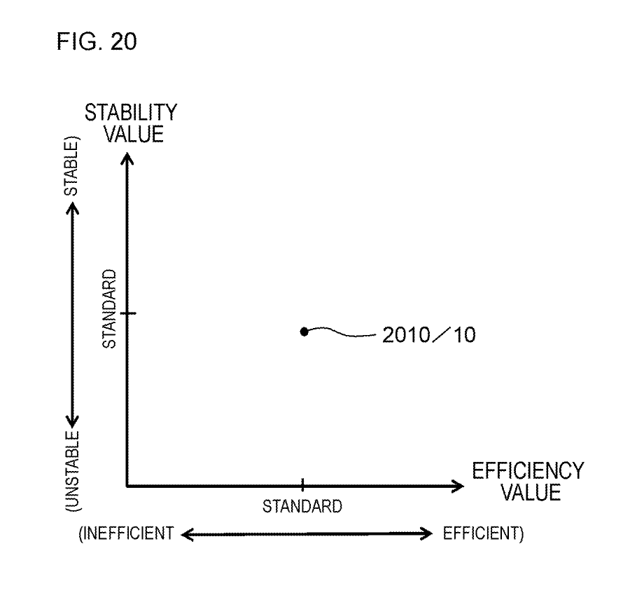

FIG. 20 shows an example of the graph display realized by the graphing unit 10. The graph shown in FIG. 20 is a graph in which the vertical axis is set to the stability value and the horizontal axis is set to the efficiency value. A point specified by “2010/10” in the graph represents the stability value and the efficiency value calculated on the basis of the operation status in the work on the first information system for one month (predetermined period) of October in 2010.

From the graph, a user can grasp the operation stability and the operation efficiency in the work on the first information system at a time.

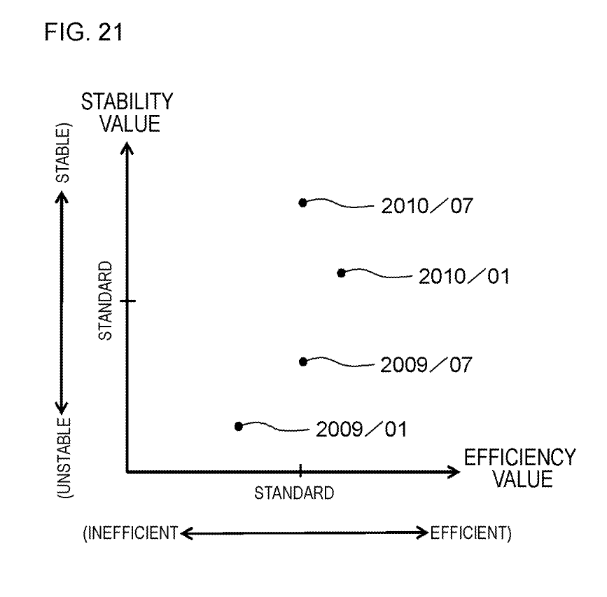

FIG. 21 shows another example of the graph display realized by the graphing unit 10. In the graph, four points specified by “2009/01”, “2009/07” “2010/01”, and “2010/07” are marked. Four points represent the stability values and the efficiency values calculated on the basis of the operation status in the work on the first information system for one month of January in 2009, one month of July in 2009, one month of January in 2010, and one month of July in 2010, respectively.

From the graph, a user can easily grasp how the operation stability and the operation efficiency in the work on the first information system vary with the lapse of time.

As shown in FIGS. 20 and 21, the graphing unit 10 can display at least one first reference value (indicated by “standard” in the drawings), which serves as a reference for determining whether the work on the first information system is stably performed, in the graph. The first reference value may include a reference value representing that the stability is good, a reference value representing that the stability is very good, a reference value representing that the stability is poor, and a reference value representing that the stability is very poor, in addition to the standard value shown in the drawings. The specific value of the first reference value is a designable factor.

The graphing unit 10 may display the graphs shown in FIGS. 20 and 21, for example, by receiving an input of the first reference value from a user who is acquainted with the stability value.

As shown in FIGS. 20 and 21, the graphing unit 10 can display at least one second reference value, which serves as a reference for determining whether the operation efficiency in the work on the first information system is good, in the graph in addition to or instead of the first reference value. The second reference value may include a reference value representing that the operation efficiency is good, a reference value representing that the operation efficiency is very good., a reference value representing that the operation efficiency is poor, and a reference value representing that the operation efficiency is very poor, in addition to the standard value shown in the drawings. The specific value of the second reference value is a designable factor.

The graphing unit 10 may display the graphs shown in FIGS. 20 and 21, for example, by receiving an input of the second reference value from a user who is acquainted with the efficiency value.

By displaying the first reference value and/or the second reference value, a user who is not acquainted with the stability value and the efficiency value can easily grasp the operation stability and the operation efficiency in the work on the first information system on the basis of the graph display. The graphing unit 10 may be configured so as not to display the first reference value and the second reference value.

The graphing unit 10 may display the stability value and the efficiency value of the first information system and stability values and efficiency values of other information systems in the graph so as to overlap with each other.

The service management system 1 according to this embodiment can be embodied, for example, by installing the following program in a computer:

A program for visualizing an operation status in work on an information system, causing a computer to serve as a graphing unit that takes a stability value, which represents an index on whether the work on the information system can be stably performed, in one axis of a graph, takes an efficiency value, which represents operation efficiency in work on the information system, in the other axis of the graph, and graphs the stability value and the efficiency value in the work on the information system.

From the above description, the following invention can be made:

An operation status visualization method of visualizing an operation status in work on an information system, including a graphing step of taking a stability value, which represents an index on whether the work on the information system can be stably performed, in one axis of a graph, taking an efficiency value, which represents operation efficiency in work on the information system, in the other axis of the graph, and graphing the stability value and the efficiency value in the work on the information system.

### Second Embodiment

An operation status visualization system 1 according to this embodiment has the same configuration as the operation status visualization system 1 according to the first embodiment, except a partial configuration of the graphing unit 10. An example of the configuration of the operation status visualization system 1 according to this embodiment is shown in the functional block diagram of FIG. 1. The graphing unit 10 will be described below.

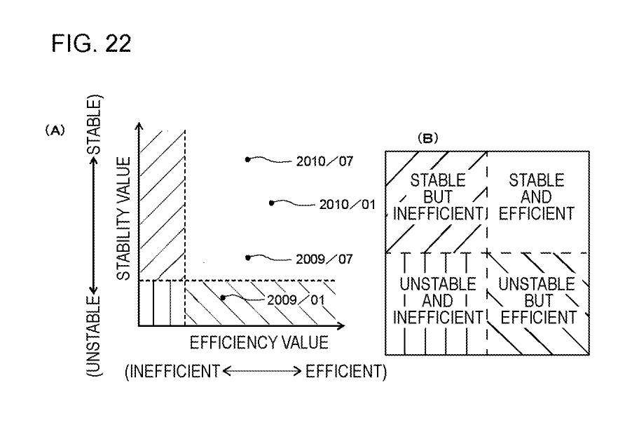

As shown in FIG. 22(A), the graphing unit 10 displays lines (dotted lines in the drawing) indicating the first reference value and the second reference value in the graph. A plane including two axes of the graph is divided into plural subareas by the lines. In the drawing, the plane is divided into four subareas.

When plural first reference values are displayed in the graph, the graphing unit 10 may display lines indicating all the first reference values or may display a line indicating a predetermined first reference value thereof. Similarly, when plural second reference values are displayed in the graph, the graphing unit 10 may display lines indicating all the second reference values or may display a line indicating a predetermined second reference value thereof.

The graphing unit 10 displays information representing the operation status in the work on the first information system which is determined on the basis of the stability values and the efficiency values included in the subareas in correlation with the subareas, as shown in FIG. 22(B).

FIGS. 22(A) and 22(B) show that the subareas hatched in the same form correspond to each other. That is, subarea A shown in FIG. 22(A) is an area representing that the operation status is stable or highly efficient, subarea B is an area representing that the operation status is stable but inefficient, subarea C is an area representing that the operation status is unstable and inefficient, and subarea D is an area representing that the operation status is unstable but highly efficient.

Means for displaying information representing the operation status in the work on the first information system in plural subareas in correlation with each other is not particularly limited. For example, the information may be displayed on the corresponding subareas shown in FIG. 22(A). In this case, the display shown in FIG. 22(B) becomes unnecessary.

The graphing unit 10 may determine the number of subareas and the shapes, positions, and sizes of the subareas and may realize the display shown in FIG. 22(A), for example, by receiving an input from a user who is acquainted with the stability values and the efficiency values.

The effects achieved by the operation status visualization system 1 according to this embodiment will be described below.

When a user is not acquainted with the stability values and the efficiency values, the user may not satisfactorily grasp the operation stability and the operation efficiency in the work on the first information system, for example, even from the graph shown in FIGS. 20 and 21.

On the contrary, the operation status visualization system 1 according to this embodiment divides the graph into plural subareas, for example, as shown in FIG. 22(A), and displays information representing the operation status in the work on the first information system, which is determined on the basis of the stability values and the efficiency values included in the subareas, in correlation with the subareas as shown in FIGS. 22(A) and 22(B).

By using the operation status visualization system 1 according to this embodiment, a user who is not acquainted with the stability values and the efficiency values can grasp the operation stability and the operation efficiency in the work on the first information system at a time.

### Third Embodiment

The operation status visualization system 1 according to this embodiment has the same configuration as the operation status visualization system 1 according to the first or second embodiment, except that it includes an accounting information acquiring unit 40 and a partial configuration of the graphing unit 10 is different.

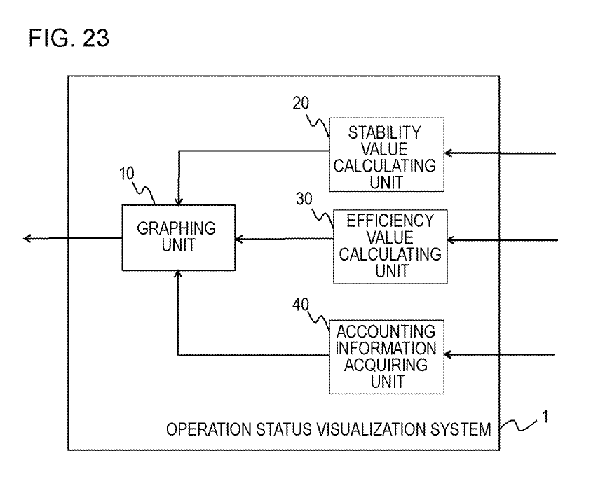

FIG. 23 is a functional block diagram illustrating an example of the configuration of the operation status visualization system 1 according to this embodiment. The operation status visualization system 1 according to this embodiment shown in FIG. 23 includes a graphing unit 10, a stability value calculating unit 20, an efficiency value calculating unit 30, and an accounting information acquiring unit 40. The configurations of the accounting information acquiring unit 40 and the graphing unit 10 will be described below.

The accounting information acquiring unit 40 acquires accounting information relevant to the performance of the work on the first information system. For example, the accounting information acquiring unit 40 acquires information representing a profit, an income, or an amount of capital investment of the work on the first information system in a predetermined period as the accounting information. The accounting information acquiring unit 40 can acquire the accounting information, for example, by receiving an input from a user.

The graphing unit 10 displays the accounting information in a graph in which one axis is set to the stability value and the other axis is set to the efficiency value. The graphing unit 10 realizes the display of the accounting information in a graph using the accounting information acquired by the accounting information acquiring unit 40.

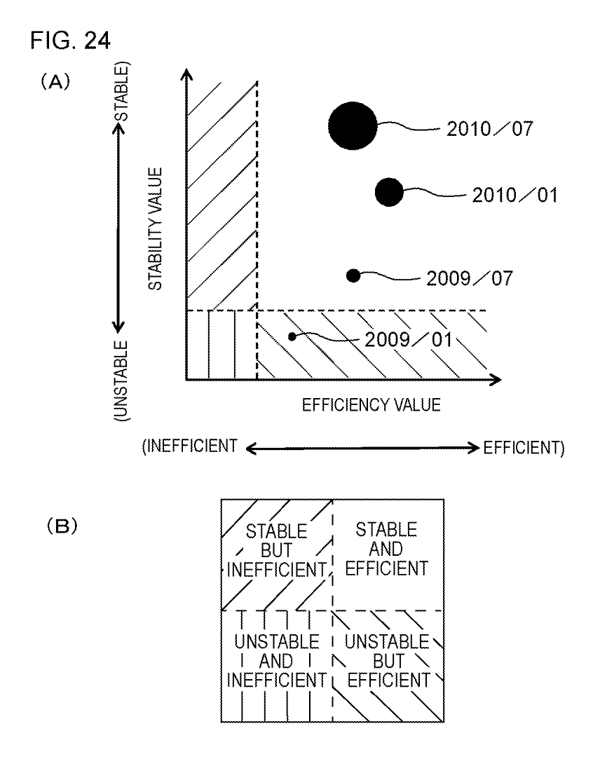

FIGS. 24(A) and 24(B) show an example of a graph display by the graphing unit 10. In the graph display, the accounting information is displayed by the use of the size of a point on the basis of the configuration of the graph display described in the second embodiment. For example, when the accounting information is information representing a profit in a predetermined period, it can be seen from the graph shown in FIG. 24(A) that the profit of the work on the first information system for one month of July in 2009 is larger than the profit of the work on the first information system for one month of January in 2009. With the lapse of time through January in 2009, July in 2009, January in 2010, and July in 2010, it can also be seen that the profit of the work on the first information system for each month increases.

The graphing unit 10 may display the accounting information in the graph through the use of other means. For example, the graphing unit 10 may display the stability value, the efficiency value, and the accounting information in a three-dimensional graph having three axes set to the stability value, the efficiency value, and the accounting information, respectively.

In the operation status visualization system 1 according to this embodiment, a user can grasp the accounting information in addition to the operation stability and the operation efficiency of the work on the first information system at a time.

This application claims is entitled to and claims the benefit of Japanese Patent Application No. 2010-248465, filed on Nov. 5, 2010, details of which are incorporated herein by reference in its entirety.

1. An operation status visualization system for visualizing an operation status in work on an information system, comprising:
a graphing unit that takes a stability value, which represents an index on whether the work on the information system can be stably performed, in one axis of a graph, takes an efficiency value, which represents operation efficiency in work on the information system, in the other axis of the graph, and graphs the stability value and the efficiency value in the work on the information system.

2. The operation status visualization system according to claim 1, further comprising:
a stability value calculating unit that calculates the stability value on the basis of at least one of a status in which a service level provided by the information system lowers, utilization efficiency of resources of the information system, a degree of introduction of a redundant configuration into the information system, a status in which heat-trapping occurs in a space in which the information system is disposed, a status in which risk prediction training in the work on the information system is performed, the number of monitoring operators who monitor the work on the information system, and consecutive work time of the monitoring operators,
wherein the graphing unit displays the graph using the stability value calculated by the stability value calculating unit.

3. The operation status visualization system according to claim 1, further comprising:
an efficiency value calculating unit that calculates the efficiency value on the basis of at least one of utilization efficiency of resources of the information system, power consumption of the information system, the number of times in which a monitoring operator who monitors the performance of the work on the information system calls out another person in relation to the performance of the work on the information system, a period of time until a fault in the work on the information system is restored after the fault occurs, and a period of time until a predetermined countermeasure against a fault in the work on the information system is started after the fault occurs,
wherein the graphing unit displays the graph using the efficiency value calculated by the efficiency value calculating unit.

4. The operation status visualization system according to claim 1, wherein the graphing unit displays at least one first reference value, which serves as a reference for determining whether the work on the information system is stably performed, in the graph.

5. The operation status visualization system according to claim 1, wherein the graphing unit displays at least one second reference value, which serves as a reference for determining whether the operation efficiency in the work on the information system is good, in the graph.

6. The operation status visualization system according to claim 1, wherein the graphing unit
displays at least one first reference value, which serves as a reference for determining whether the work on the information system is stably performed, and at least one second reference value, which serves as a reference for determining whether the operation efficiency in the work on the information system is good, in the graph,
displays lines indicating the first reference value and the second reference value in the graph to divide a plane including the two axes of the graph into a plurality of regions by the use of the lines, and
displays information representing the operation status of the work on the information system determined on the basis of the stability value and the efficiency value included in each of the plurality of regions to correspond to each of the plurality of regions.

7. The operation status visualization system according to claim 1, wherein the stability value and the efficiency value are the stability value and the efficiency value in the work on the information system in a predetermined period, and
wherein the graphing unit displays the stability values and the efficiency values, which are calculated for each of the plurality of predetermined periods, in the graph by displaying a time series of the plurality of predetermined periods in the graph.

8. The operation status visualization system according to claim 1, wherein the graphing unit displays accounting information associated with the performance of the work on the information system in the graph.

9. The operation status visualization system according to claim 8, further comprising:
an accounting information acquiring unit that acquires information representing a profit or an income of the work on the information system as the accounting information,
wherein the graphing unit displays the graph using the accounting information acquired by the accounting information acquiring unit.

10. An information storage medium storing a program for visualizing an operation status in work on an information system, causing a computer to serve as:
a graphing unit that takes a stability value, which represents an index on whether the work on the information system can be stably performed, in one axis of a graph, takes an efficiency value, which represents operation efficiency in work on the information system, in the other axis of the graph, and graphs the stability value and the efficiency value in the work on the information system.

11. An operation status visualization method of visualizing an operation status in work on an information system, comprising:
a graphing step of taking a stability value, which represents an index on whether the work on the information system can be stably performed, in one axis of a graph, taking an efficiency value, which represents operation efficiency in work on the information system, in the other axis of the graph, and graphing the stability value and the efficiency value in the work on the information system.

12. The operation status visualization system according to claim 2, further comprising:
an efficiency value calculating unit that calculates the efficiency value on the basis of at least one of utilization efficiency of resources of the information system, power consumption of the information system, the number of times in which a monitoring operator who monitors the performance of the work on the information system calls out another person in relation to the performance of the work on the information system, a period of time until a fault in the work on the information system is restored after the fault occurs, and a period of time until a predetermined countermeasure against a fault in the work on the information system is started after the fault occurs,
wherein the graphing unit displays the graph using the efficiency value calculated by the efficiency value calculating unit.

13. The operation status visualization system according to claim 2, wherein the graphing unit displays at least one first reference value, which serves as a reference for determining whether the work on the information system is stably performed, in the graph.

14. The operation status visualization system according to claim 3, wherein the graphing unit displays at least one first reference value, which serves as a reference for determining whether the work on the information system is stably performed, in the graph.

15. The operation status visualization system according to claim 2, wherein the graphing unit displays at least one second reference value, which serves as a reference for determining whether the operation efficiency in the work on the information system is good, in the graph.

16. The operation status visualization system according to claim 3, wherein the graphing unit displays at least one second reference value, which serves as a reference for determining whether the operation efficiency in the work on the information system is good, in the graph.

17. The operation status visualization system according to claim 4, wherein the graphing unit displays at least one second reference value, which serves as a reference for determining whether the operation efficiency in the work on the information system is good, in the graph.

18. The operation status visualization system according to claim 2, wherein the stability value and the efficiency value are the stability value and the efficiency value in the work on the information system in a predetermined period, and wherein the graphing unit displays the stability values and the efficiency values, which are calculated for each of the plurality of predetermined periods, in the graph by displaying a time series of the plurality of predetermined periods in the graph.

19. The operation status visualization system according to claim 3, wherein the stability value and the efficiency value are the stability value and the efficiency value in the work on the information system in a predetermined period, and wherein the graphing unit displays the stability values and the efficiency values, which are calculated for each of the plurality of predetermined periods, in the graph by displaying a time series of the plurality of predetermined periods in the graph.

20. The operation status visualization system according to claim 4, wherein the stability value and the efficiency value are the stability value and the efficiency value in the work on the information system in a predetermined period, and
wherein the graphing unit displays the stability values and the efficiency values, which are calculated for each of the plurality of predetermined periods, in the graph by displaying a time series of the plurality of predetermined periods in the graph.
